(19) United States
(12) Patent Application Publication
(10) Pub. No.: US 2008/0243547 A1
(43) Pub. Date: Oct. 2, 2008

(54) CREATING COMPUTER AIDED MEDICAL RECOMMENDATIONS

(76) Inventors: David Brett, Neunkirchen am Brand (DE); Renas Rechid, Hausen (DE)

Correspondence Address: 24IP LAW GROUP USA, PLLC, 12 E. LAKE DRIVE, ANNAPOLIS, MD, 21403, US

(21) Appl. No.: 11/693,870

(22) Filed: Mar. 30, 2007

(51) Int. Cl. G06Q 50/00

(52) U.S. Cl. 705/3

(57) ABSTRACT

A computer aided method and apparatus for decision support within a medical investigation of a patient. The method comprises the steps of integrating and analyzing patient related data such particular symptoms and insurance related data; querying a recommendation support module with the patient related data and the insurance related data; deriving a recommendation for a patient treatment dependant on the patient related data and on the insurance related data.

### CROSS-REFERENCE TO RELATED APPLICATIONS

None.

### STATEMENT REGARDING FEDERALLY SPONSORED RESEARCH OR DEVELOPMENT

None.

### BACKGROUND OF THE INVENTION

1. Field of the Invention

The present invention relates to a computer aided method and an apparatus for generating patient specific recommendations for patient treatment within a medical investigation. The recommendations are based on symptoms and disease characteristics, patient demographics and personal insurance status.

2. Brief Description of the Related Art

A medical practitioner, whether in general practice in the primary care sector or within a hospital or outpatient clinic setting, is challenged with the task of finding the correct treatment or diagnosis for a patient based on the best available information for the presenting symptoms/illness. Additional important criteria may include the reimbursement policies or procedures of the patient's insurance and/or the local health authority with respect to this condition or diagnosis.

In recent years the medical decision process has been influenced by a growing number of Clinical Decision Support (CDS) systems available to the physician either as an integrated module within an existing hospital information system or as a stand alone web based service. The majority of CDS systems deliver information such as disease symptoms, links to evidence based medical guide lines and current trials. In many cases the software can guide physicians through certain decision paths based on presenting patient symptoms and create order sets for the next step in the clinical workflow. To date these software modules are static rule based systems purely focused on the clinically or medically relevant questions raised by a presenting patient.

However, in the majority of cases today, a final decision as to which diagnostic test, medical procedure or medication the patient receives is dependant on a wider range of individual patient or local institute specific factors. These factors can be subdivided into two main groups. Patient specific personalized information and local or regional information effecting the decision in both the short or medium term.

Information pertaining only to the patient in question can vary. This can be both of a medical or non-medical nature. Personalized medically relevant information can include genetic background information, specific tests for allergy or adverse drug response, number of hospital referrals and medication history.

Personalized non-medical information can include insurance status and therefore the willingness of the insurer to reimburse the cost of the procedure or medication, or local access to health care provision based on place of residence or affiliation.

It would be foreseen in this patent that this type of personalized information will in the future be delivered through the introduction of the electronic health record (EHR).

Most medical decisions are influenced by the budgetary guide lines laid out either by the insurer or the local health authority, hospital/clinic or region. These reimbursements constraints or guide lines affect every aspect of the patient's encounter with the health provider. They influence the destination of the patient, which type of medical institute and both quality and frequency of procedure undertaken or medication offered. Within these constraints a physician should have access to dynamic information on a local level.

Up until now there has been no CDS support for physicians making these decisions and most are made based on local knowledge, experience and short term need for a solution with pressure from either hospital or primary care administrators or the patient themselves.

For example, to allow a physician a more clear and comprehensive view of practical and financial possibilities with regard to a patient, there is a need for a particularly computer-based method which is able to link and combine present patient symptoms or clinical results with information sources, i.e., databases derived either from a personal level from a electronic health record (EHR) or from integrated dedicated databases. Such database sources could provide for a wide range of information. For example, they can include static evidence-based medicine guide lines, local health provider data or insurance reimbursement structures for medical conditions. They can provide the physician with the latest recommendations and treatment options which are suitable for the patient.

Thus in recent years, the patient insurance and/or the local health authority recommendations have become very important with respect to which particular treatment or course of action the physician recommends.

In reiteration of the above, there is a need for a method that is able to process special types of information and to recommend correct, i.e., problem adapted clinical treatment options under consideration of the insurance status of the patient and the reimbursement structure of the health provider.

Such a method would not only recommend the most relevant evidence based medical treatment of diagnostic clinical decision path for a patient but would indicate at each step of the medical investigation what is available both financially and practically for the patient.

### SUMMARY OF THE PRESENT INVENTION

In one embodiment, the present invention is a method for decision support within a medical investigation of a patient. The method is computer aided and comprises the steps of:
Receiving (for example integrating and/or analyzing) patient related data (particularly one or more patient symptoms) and/or insurance related data;
Querying at least one recommendation support module with the patient related data and/or the insurance related data; and
Deriving at least one recommendation for at least one patient treatment dependant on the relevant patient related data and/or on the insurance related data.

The method for decision support according to the invention is computer aided, i.e., totally or at least partially computer based and the kind of computer for executing the method is not limited to only one specific type of computer. The computer may be a handheld like a personal digital assistant (PDA), a laptop computer, stand alone personal computer (PC) or workstation, a server computer, or any other type of an electronic data processing apparatus. Such a computer can also be connected to other computers, databases, etc. via a communications network using interfaces.

To find out the best medical treatment for the patient under consideration of his insurance status, his medical history, i.e., anamnesis, previous medication etc., the physician executes the method according to the invention on his or her computer. Then, the physician receives a recommendation about the next steps for the medical treatment of the patient. Such a recommendation can support a decision or change the patient treatment.

In the following there is an exemplary illustration of individual actions or steps of the method according to the invention. It is to be noted that these steps could be executed independently or separately or in combination with variable chronology.

Patient specific or patient related personalized information can be of medical and/or a non-medical type. Personalized medical relevant information can comprise genetic background information, allergy test information, adverse drug response information, hospital referrals and stays and medication history data.

Patient related non-medical information can include the name, age, gender and insurance status. The insurance status represents the willingness of the insurer to reimburse the costs of medical procedures such as examinations, medications, local access to health care provision based on place of residence or affiliation, etc.

Patient related data can comprise in particular patient symptom data, i.e., one or more patient symptoms such as nephrology, etc.

Integrating and analyzing patient related data or patient specific data or a portion of the patient related data and/or insurance related data can be, for example, inter alia automatically collecting or receiving such data from an internal and/or external database with the database storing the patient related data or information. According to another aspect of the invention the patient related data and the insurance related data may be received (integrated and analyzed) in parallel (in the same time span) or sequentially (possibly in different periods of time). This allows more flexibility and allows computing a first result, solely based on the patient related data, whereby this first result may subsequently be filtered according to the insurance related data for getting a second result as a recommendation.

Integrating and analyzing patient related data or patient specific data and/or insurance related data can also comprise detecting the patient related data.

In accordance with another embodiment of the invention, the method can be, for example, initialized only with integrating patient related data and/or insurance related data.

The database may be a electronic health record (EHR) database with an optional clinical decision support (CDS) system and may further comprise demographic information, medication and procedure history, genetic test results and insurance status information of the patient or any other kind of information that is associated with a patient.

Further, at least portions of patient related data, particularly patient symptoms, can be directly or indirectly recorded and received from a medical modality. The medical modality may be, for example, selected from the group of computer assisted tomographs, mammographic apparatuses, endoscopic apparatuses, magnetic resonance imaging apparatuses, radiographic apparatuses, ultrasonographic apparatuses, position emission tomographs or any other medical apparatus for generating at least a portion of patient related data and combinations thereof.

In another example of the invention, integrating and analyzing patient related data and/or insurance related data can comprise manual input via a user interface or automatic input via another interface to other medical modules (i.e., computer of an external physician).

Querying a recommendation support module with the integrated and/or analyzed patient related data and/or the insurance related data may further comprise accessing the recommendation support module.

The recommendation support module can be a module of the CDS system or a CDS module. Accessing of the recommendation support module can be a dynamical accessing, i.e., only user selectable or user selected or pre-configured portions of patient related information is transmitted to the recommendation module to initialize a query. The recommendation support module may be implemented in hardware or in software or in hardware and software.

Querying the recommendation support module can happen in particular with patient symptom data or without patient symptom data (possibly with other patient related data and/or insurance related data). Querying may further be based on a specifically adopted user interface with predefined commands.

Deriving a recommendation for a patient treatment or options of a patient treatment dependant on the patient related data and/or the insurance related data can be, in another example of the invention, automatically deriving of one or more suitable treatment actions or medical treatment steps for the patient with the detected symptoms. A recommendation can include further medication, further diagnosis and/or therapy advices or instructions for adjusting medical modalities, etc. This can lead to improve and optimize the process of making a decision for the further treatment of the patient.

According to another embodiment of the invention, a recommendation can comprise warnings in relation to the patient condition, information from previous treatments, etc. Deriving the recommendation can be an automatic calculation based on intelligent software development mechanisms, while optionally accessing database sources.

The invention may further comprise executing of the recommendation support module and generating a recommendation for a patient treatment can further lead to automatic or half-automatic controlling a medical modality, for example, as described above, dependant on the recommendation.

According to a further example of the invention, integrating and analyzing patient related data can further comprise determining and/or calculating insurance related data dependant on a derived recommendation or dependant on the patient related data such as patient symptoms.

Insurance related data can, for example, comprise information about how far costs for medical, i.e., health related services are fully or at least partially covered, etc.

The method according to the invention allows, for example, the health provider personnel to decide a correct, i.e., situation adapted treatment or treatment options based on both clinical evidence and what is allowable or affordable for a patient with respect to his insurance status. With other words, the result of the method comprises a combination of medical (or patient related) data and insurance related data.

The method for decision support may further comprise displaying the derived recommendation and/or displaying the patient related data and/or displaying the derived insurance related data on a display device, indicating a reimbursement of costs.

The display device may be a computer monitor, LCD display or any other type of display devices. This aspect of the invention provides, for example, that the physician gets a quick overview about the patient treatment and insurance status.

Integrating and analyzing patient related data can further comprise receiving the patient related data from a medical modality.

Querying the recommendation support module can further comprise connecting the recommendation support module with at least one database and/or external information source wherein the database and/or the external information source stores relevant data of the patient, particularly insurance data of the patient. The at least one database and/or the external information sources can comprise literature studies, international medical guidelines, etc.

The database can be an external database and can be connected to the insurer's site. The database can contain guide line information for every patient with respect to reimbursement of costs of medical services, etc.

Deriving a recommendation can further comprise filtering and/or analysing the data. Filtering and/or analysing can be realized using pre-configured rules or can be set dynamically in accordance with user defined rules. This aspect leads, for example, to faster results, i.e., the recommendation generation is accelerated, because only specific patient related data used. The filtering, analysing and/or solution may be referred to input and/or output data of the recommendation process.

The method for decision support may further comprise triggering patient treatment or at least one action of the patient treatment dependant on insurance related data, for example, for which the insurance related data indicate that costs will be reimbursed. This aspect saves time and is very cost-effective within a medical investigation, i.e., for example, within a medical question situation of the patient, set of medical questions or problems, diagnosis, medical treatments, therapies, medications, examinations, medical checking and the like.

The recommendation for the patient treatment comprises advice and associated support information for medication, therapies, diagnosis and/or examination procedures or combinations thereof. Such a recommendation helps the physician to specify the further proceeding(s) with regard to an optimal treatment of the patient in a more effective way.

The method for decision support may comprise transmitting the recommendation to a computerized physician order entry (CPOE) module. This allows, for example, using and processing such information within a CPOE system where the recommendation can be communicated over a telecommunications network to the medical staff (nurses, therapists, physicians, etc.).

The patient related data can comprise personal data, therapy data, actual condition data of the patient, disease progress data, HER patient data or combinations thereof. For example, this aspect ensures that all relevant and important data is concentrated in one single information carrier. This leads to minor administration effort.

The method for decision support may comprise checking the availability of patient treatment dependant on the patient related data or dependant on the derived recommendation. This aspect leads to a quick decision of the physician for ordering, for example, additional not indispensable patient treatment steps or not.

The querying the recommendation support module may be dynamically configurable. The query can be, for example, configured and realized by manual input of a physician or executed automatically and computer based by a predefined set of rules. This leads to more flexibility, time saving and effectiveness of deriving a recommendation for the patient treatment, for example, dependant on available insurance data of a patient.

The method for decision support may comprise searching for alternative patient treatments or alternative actions of patient treatment in case that a evaluation of the insurance data of a patient indicate that costs for one or more derived recommendations, i.e. treatment steps will not be reimbursed.

According to another embodiment of the invention there is provided an apparatus for medical decision support within a medical investigation of a patient. The apparatus comprises at least one patient data integration and analysis module for the integration and analysis of at least one aspect of patient related data, particularly of one or more patient symptoms. The apparatus according to the invention further comprises at least one insurance module for the integration and analysis and/or calculation of insurance related data. The apparatus further comprises at least one recommendation support module for reception of queries based on the patient related data and/or the insurance related data and for derivation of at least one recommendation for the patient treatment dependant on the patient related data and/or the insurance related data.

For example, the apparatus may be designed in hardware and/or may be part of a data processing apparatus such as a personal computer, laptop, server and the like.

The apparatus can further comprise a display device, such a monitor, computer screen, LCD display or any other device for visualising information.

The apparatus can further comprise a database storing patient relevant information such as personal data, EHR information, etc. The database may be a local hard disc drive, a floppy drive, CD or DVD drive, USB storage device, etc.

The apparatus may be part of a clinical decision support (CDS) system. This aspect leads to a more efficient and optimized operational mode of such an information system.

In accordance with another embodiment of the invention, a computer readable tangible medium is provided. The computer readable medium stores instructions for implementing a process driven by a computer, the instructions controlling the computer to perform the method for decision support within a medical investigation of a patient, wherein the method is computer aided and comprises:

Integrating and/or analyzing patient related data, particularly symptoms and/or insurance related data;

Querying a recommendation support module with the patient related data and/or with the insurance related data;

Deriving a recommendation for a patient treatment dependant on the patient related data and/or on the insurance related data;

The computer readable tangible medium can be a floppy disk, CD-ROM, DVD, hard disk, USB memory storage device, etc. In an alternative example of the present invention, the method can be stored on a server and downloaded from the server via a communications network such as the intranet or Internet.

According to another embodiment of the invention, a computer program product is provided. The computer program product is loadable into at least one memory of a computer readable tangible medium or into an electronic data processing apparatus. The computer program product comprises program code means to perform the method for decision support within a medical investigation of a patient, wherein the method is computer aided and comprises:

Integrating and/or analyzing patient related data, particularly symptoms and/or insurance related data;

Querying a recommendation support module with the patient related data and/or with the insurance related data;

Deriving a recommendation for a patient treatment dependant on the patient related data and/or on the insurance related data;

These together with other possible and exemplary embodiments and objects that will be subsequently apparent, reside in the details of construction and operation as more fully herein described and claimed, with reference being had to the accompanying figures. It is clear for a person of ordinary skill in the art that the disclosed characteristics, features and embodiments of the invention can be arbitrarily combined with each other.

Still other aspects, features, and advantages of the present invention are readily apparent from the following detailed description, simply by illustrating a preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature, and not as restrictive. Additional objects and advantages of the invention will be set forth in part in the description which follows and in part will be obvious from the description, or may be learned by practice of the invention.

### BRIEF DESCRIPTION OF THE DRAWINGS

For a more complete understanding of the present invention and the advantages thereof, reference is now made to the following description and the accompanying drawings, in which:

FIG. 1 is a schematic overview of an example of the method according to the invention;

FIG. 2 is a schematic overview of an example of the apparatus according to the invention.

### DETAILED DESCRIPTION OF THE PREFERRED EMBODIMENTS

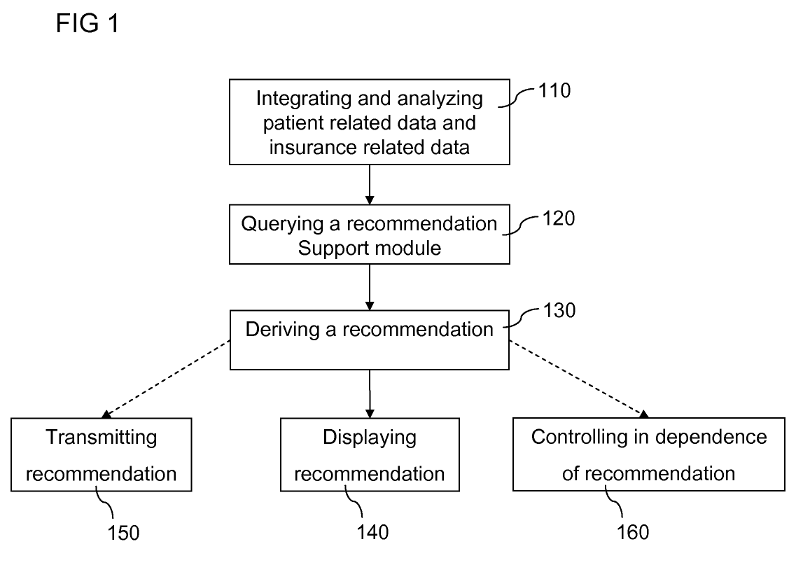

FIG. 1 shows a two-dimensional schematic overview of an example of the computer based or computer aided method according to the invention. With reference to FIG. 1, the example of the method according to the invention is initialized with integrating and analyzing patient specific, i.e., patient related data and insurance related data of the patient 110.

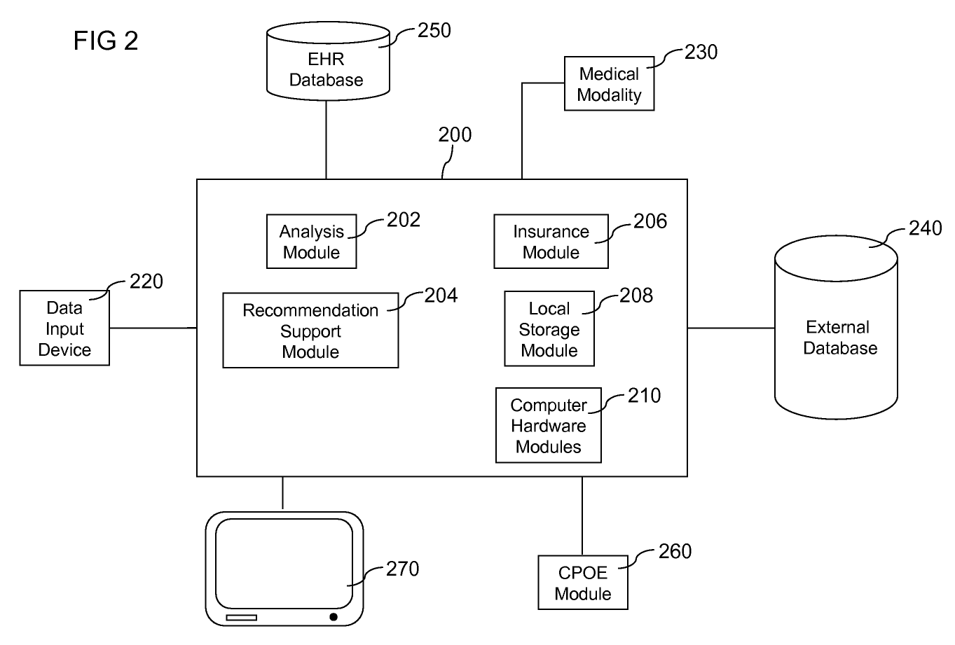

The patient related data contains information which can be associated to several categories. In particular the patient related data may comprise current patient symptom data. The patient symptom data can be, for example, manually entered by a physician into an electronic data processing apparatus such as a personal computer via a computer keyboard wherein the electronic data processing apparatus may be connected to a CDS system. Alternatively, patient symptom data can be generated by a medical modality 230 (see FIG. 2) such as a computer assisted tomography or received from a database as a result of a query. The patient symptom data represents the particular set of symptoms of patient due to a disease and the like.

Further, the patient related data can comprise information from an electronic health record (EHR) database 250 (see FIG. 2) such as demographic data, medication and procedure history data, genetic test result data and the like.

In addition, patient related data can comprise data that is relevant for the patient and its medical treatment. Such information are, for example, local available treatment or procedure options including waiting times, bed availability, bench marked local or regional hospital or clinic performance tables, local available new treatment options, diagnostic procedures, clinical trials, etc. Such information which is related to a hospital can be customized, i.e., adapted for the patient's insurance status.

Integrating and/or analyzing such data also may comprise inquiring an external database 240, 250 (see FIG. 2), i.e., a database from an insurer storing current insurance status data of the patient.

Further, integrating and/or analyzing patient related data and/or insurance related data also may comprise controlling and/or correcting the patient related data and/or insurance related data.

Next, at step 120 a query with the patient related data and the insurance related data is transmitted to a recommendation support module 204 (see FIG. 2). The recommendation support module 204 (see FIG. 2) may be a hardware component or a software component or a combination of a hardware and a software component.

According to an alternative embodiment of the invention, querying the recommendation support module 204 can be dynamically configurable. For example, the relevant portions or properties of the patient related data and/or insurance related data can be determined using configurable sets of rules or determined manually by a user such as a physician.

Querying the recommendation support module 204 (see FIG. 2) also may comprise controlling of the query with regard to possible mistakes concerning to patient symptom data or the like.

In the following step 130, a recommendation for a patient treatment dependant on the patient related data and/or the insurance related data is derived within the recommendation support module 204 (see FIG. 2). Deriving may comprise, for example, linking and/or combining current patient symptom data or clinical results of a patient with information of different categories. The recommendation may comprise one or more steps of patient treatment.

In another example of the method according to the invention, deriving a recommendation for a patient treatment comprises transforming at least a portion of the patient related data and/or the insurance related data before the recommendation is derived.

Alternatively, portions of patient related data can be compared with other portions of patient related data or amended such that the amendments are dependant on further external information, e.g. medical publications, knowledge about new diagnosis procedures, etc.

Deriving a recommendation or more recommendations for a patient treatment can further comprise selecting only a pre-defined number of favoured recommendations. The number of derived favoured recommendations can be set manually or automatically.

Alternatively, the method according to the invention can comprise calculating insurance related data for a derived recommendation dependent on only patient symptom data for a patient treatment.

As mentioned above, a recommendation can comprise, for example, patient specific, static or dynamic, regional and/or local information as well as a prognosis for further patient treatment based on the entered or detected patient symptoms and the insurance status information of the patient.

The insurance related data can also be used to modify and/or adapt the recommendation for the patient treatment or to provide alternative recommendations for patient treatment dependant on the insurance status of the patient and/or the local health provider guide lines and/or reimbursement structure.

Alternatively, the insurance related data can be used to amend at least a portion, i.e., a step of the patient treatment dependant on the patient related data and/or the recommendation for the patient treatment.

Alternatively, calculating insurance related data for a derived recommendation may further comprise calculating several different allowable or affordable patient treatment procedures, medications, etc.

Next, the derived recommendation for patient treatment and/or the calculated insurance related data can be visualized on a display device such as a monitor at step 140. In particular, this can support a physician in his decision process for the further proceeding with regard to the medical treatment of the patient.

Alternatively or additionally the recommendation and/or the insurance related data can be transmitted to a hospital information system, for example, a CDS system for further proceedings, at step 150.

In an alternative example of the method according to the invention the insurance related data may be derived or calculated in dependence of the patient related data and/or the recommendation for the patient treatment at step 160. Following, the recommendation support module 204 (see FIG. 2) for deriving a recommendation for a patient treatment may be queried with only the patient related data.

According to an alternative example of the inventive method, the method is initialized with receiving patient related data and then querying a recommendation support module with the patient related data. The patient related data comprises only patient symptom data of the patient. Then a recommendation is generated, i.e., derived in dependence of the patient related data. Next, insurance related data can be calculated and/or determined showing whether for the forecasted condition or conditions the patient is eligible to be treated by a specific provider based on the insurance status of the patient and/or the health provider or insurer reimbursement guide lines.

Alternative local and/or regional providers offering affordable treatment, based on insurance status of the patient, can be identified and displayed to the physician and the patient. The recommendation and/or the insurance related data of the patient can further comprise, for example, co-pay options and/or additional private insurance rates.

Deriving a recommendation and/or deriving or detecting the patient's insurance related data can further comprise generating specific guide lines for a clinical workflow and outlining treatment options for the patient for each step of the treatment. For example, for each procedure within a patient treatment, an order set represented by the recommendation can be derived.

The method according to the invention can be used within a CDS system wherein the CDS system can register automatically the recommendation and/or the insurance related data of the patient in a computerized physician order entry module. Then, data can be filtered and order sets for those medications and medical procedures allowable under consideration of the patient's insurance status can be customized.

Filtering can also comprise information generation wherein the information is derived from the longitudinal patient's record or disease management scheme and/or special affiliated group status.

FIG. 2 is a schematic overview of an example of the apparatus 200 according to the invention. The apparatus 200 may be a hardware component, i.e., a hardware device. In another example of the invention portions of the apparatus 200 may be realized within software functionalities.

A data input device 220 such as a computer keyboard and/or a mouse is connected to the apparatus 200. A user such as a physician can control the computer based or computer aided method according to the present invention via the data input device 220. The method is executed within the apparatus 200 according to the present invention.

The apparatus 200 further comprises a patient data integration and analysis module 202. The patient data integration and analysis module 202 is able to request, receive, analyse, filter, control and/or detect patient related data from any information source or information database 230, 240, 250 that is connected to the apparatus 200.

Further, the apparatus 200 comprises a recommendation support module 204 for the reception of one or more queries based on the patient related data and/or the insurance related data for the derivation of one or more recommendations for patient treatment in dependence of the patient related data such as patient symptoms and/or patient insurance status data.

The apparatus 200 comprises further an insurance module 206 for the calculation or detection of insurance related data for the derived recommendation of the recommendation support module 204 for the patient treatment or for the calculation or detection of insurance related data from the patient related data of the patient data integration and analysis module 202.

Further, the apparatus 200 comprises a local storage module 208 and further commonly known computer hardware modules 210 such as a central processing unit, RAM/ROM storage devices, etc. According to another aspect of the invention, the apparatus 200 may be part of a personal computer, a laptop computer or the like.

The apparatus 200 in FIG. 2 may be connected to an electronic health record (EHR) database 250 storing inter alia patient related data such as medication and procedure history as well as current medical literature and articles, etc.

Further, the apparatus according to the invention can be connected with a medical modality 230, i.e., a medical examination device. Such a medical modality 230 can automatically detect and provide patient symptoms within a patient examination for the execution of the method according to the invention.

The apparatus 200 is further connected to an external database 240. Such an external database 240 can include insurance status data of patients and administrated by the insurer of the patients.

For the person skilled in the art it is evident that the apparatus 200 may also comprise a plurality of communications interfaces for communicating with external periphery devices, databases, etc.

The apparatus 200 is further connected to a display device 270 for the display of recommendations and/or insurance related data with regard to the further medical treatment of the patient.

In addition, the apparatus 200 can be connected with a CPOE module 260 to be able to check for alternative external health care providers and for other options matching the insurance status or for order set generation for specific treatment options based on the allowable insurance status of the patient.

The invention has been described in terms of single examples. The man skilled in the art will recognize that the invention can be practiced with modification within the spirit and scope of the attached claims.

At least, it should be noted that the invention is not limited to the detailed description of the invention and/or of the examples of the invention. It is apparent for the person skilled in the art that the invention can be realized at least partially in hardware and/or software and can be transferred to several physical devices or products. The invention can be transferred to at least one computer program product. Further, the invention may be realized with several devices.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. A method for decision support within a medical investigation of a patient, wherein the method is computer aided and comprises:
analyzing and integrating patient related data and insurance related data;
querying a recommendation support module with the patient related data and with the insurance related data; and
deriving a recommendation for a patient treatment dependant on the patient related data and on the insurance related data.

2. The method according to claim 1, further comprising the step of:
displaying the derived recommendation, the patient related data and the insurance related data, indicating a reimbursement of costs.

3. The method according to claim 1, wherein said step of analyzing and integrating patient related data further comprises the step of:
receiving the patient related data from a medical modality or a database.

4. The method according to claim 1, wherein the patient related data and the insurance related data may be integrated and analyzed in the same or in a different period of time.

5. The method according to claim 1, wherein the step of querying the recommendation support module further comprises the step of:
connecting the recommendation support module with at least one database, the database storing insurance data of the patient.

6. The method according to claim 1, wherein said step of deriving a recommendation further comprises the step of:
filtering the patient related data.

7. The method according to claim 1, further comprising the step of:
triggering patient treatment dependant on the insurance related data.

8. The method according to claim 1, wherein the recommendation for the patient treatment comprises advice on medication, therapies, diagnosis and examination procedures or combinations thereof.

9. The method according to claim 1, further comprising the step of:
transmitting the recommendation to a computerized physician order entry (CPOE) module.

10. The method according to claim 1, wherein the patient related data comprises personal data, therapy data, actual condition data, disease progress data, EHR patient data or combinations thereof.

11. The method according to claim 1, further comprising the step of:
checking availability of a recommended patient treatment.

12. The method according to claim 1, wherein said querying the recommendation support module is dynamically configurable.

13. A computer readable tangible medium storing instructions for implementing a process driven by a computer, the instructions controlling the computer to perform the method for decision support within a medical investigation of a patient, wherein the method is computer aided and comprises:
integrating and analyzing patient related data and insurance related data;
querying a recommendation support module with the patient related data and with the insurance related data; and
deriving a recommendation for a patient treatment dependant on the patient related data and on the insurance related data.

14. A computer program product being loadable into at least one memory of a computer readable tangible medium or into an electronic data processing apparatus, the computer program product comprising program code means to perform the method for decision support within a medical investigation of a patient, wherein the method is computer aided and comprises:
integrating and analyzing patient related data and insurance related data;
querying a recommendation support module with the patient related data and with the insurance related data; and
deriving a recommendation for a patient treatment dependant on the patient related data and on the insurance related data.
